(19) United States
(12) Patent Application Publication
(10) Pub. No.: US 2011/0044051 A1
(43) Pub. Date: Feb. 24, 2011

(54) CONDUCTIVE ELEMENT AND LAMP USING THE SAME

(75) Inventors: Chung Ping Wu, Hsinchu City (TW); Ting Ping Hsiao, Hsinchu City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Glory Praise Photronics Corp., Hsinchu City (TW)

(21) Appl. No.: 12/546,427

(22) Filed: Aug. 24, 2009

(51) Int. Cl. F21V 7/00; H01R 13/02

(52) U.S. Cl. 362/296.01; 439/890

(57) ABSTRACT

A conductive element and a lamp using the same are described. The conductive element includes a sleeve portion and a conductive portion, and the conductive element is applied to a lamp reflector. The lamp reflector has a main body and a neck portion connected to each other. The sleeve portion of the conductive element is installed in the neck portion, and then a discharge lamp tube through from the main body to the sleeve portion in the neck portion, and the conductive portion forms an included angle with the discharge lamp tube. Therefore, a length achieved after the discharge lamp tube and the lamp reflector are assembled together is shortened.

### BACKGROUND OF THE INVENTION

1. Field of the Invention

The present invention relates to a lamp, and more particularly to a conductive element and a lamp using the same.

2. Related Art

A high-intensity discharge (HID) lamp is a type of electrical lamp which produces light by means of an electric arc between tungsten electrodes housed inside a translucent or transparent fused quartz or fused alumina arc tube. This tube is filled with both gas and metal salts. A positive electrode and a negative electrode are respectively disposed on two ends of the lamp tube. Tip portions of the two electrodes respectively extend into the cavity of the tude and correspond to each other. After power is supplied to the electrodes, the tip portions of the two electrodes generate an arc light to excite the gas within the cavity into an ionization state, so as to emit light in the cavity of the lamp tube.

Generally, an HID lamp is assembled inside a reflector. For example, in U.S. Pat. No. 5,506,464, a lamp cap is installed on one end of a gas discharge lamp and wraps the end of the gas discharge lamp, so that the gas discharge lamp is fixed and prevented from shaking, and a wire at one end of the gas discharge lamp is electrically connected to an electric contact on the lamp cap. Another prior art, for example, U.S. Pat. No. 6,505,958, discloses a reflector without disposing of a lamp cap. Two contact members are respectively disposed on the reflector, such that conductive wires at two ends of a gas discharge lamp are electrically connected to the corresponding contact members respectively.

### SUMMARY OF THE INVENTION

Accordingly, the present invention provides a conductive element, which is applicable to a lamp having a discharge lamp tube. The conductive element comprises a sleeve portion and a conductive portion. The conductive portion extends from one side of the sleeve portion such that an included angle is formed between the conductive portion and the discharge lamp tube.

The present invention further provides a lamp, which comprises a lamp reflector, a conductive element, and a discharge lamp tube. The lamp reflector comprises a main body and a neck portion connected to the main body. The main body has a reflecting chamber therein, and the neck portion has a receiving chamber and an opening. The opening goes through the neck portion, such that the receiving chamber communicates with the reflecting chamber. The conductive element comprises a sleeve portion and a conductive portion, in which the sleeve portion is installed within the receiving chamber, and the conductive portion extends from the sleeve portion and an included angle is formed between the conductive portion and the discharge lamp tube. The discharge lamp tube is disposed within the reflecting chamber, and has a first end and a second end. The first end goes through the opening and the sleeve portion, and the first end has a first wire electrically connected to the conductive portion.

The conductive element and the lamp using the conductive element according to the present invention have the following effects. After the sleeve portion of the conductive element is sleeved on a gas discharge lamp, the conductive portion of the conductive element forms an included angle with the discharge lamp tube. Then, the wire at one end of the gas discharge lamp is soldered on the conductive portion. Through such a structural design, a length after the discharge lamp tube and the lamp reflector are assembled together may be shortened, thereby effectively solving a problem that the wire is exposed.

### BRIEF DESCRIPTION OF THE DRAWINGS

The present invention will become more fully understood from the detailed description given herein below for illustration only, and thus is not limitative of the present invention, and wherein:

FIG. 1A is a schematic view of a conductive element according to an embodiment of the present invention;

FIG. 1B is a schematic view of a conductive element according to another embodiment of the present invention;

FIG. 2 is a schematic exploded view of a lamp according to an embodiment of the present invention;

FIG. 3 is a schematic view of the lamp according to an embodiment of the present invention; and

FIG. 4 is a schematic cross-sectional view of the lamp according to an embodiment of the present invention.

### DETAILED DESCRIPTION OF THE INVENTION

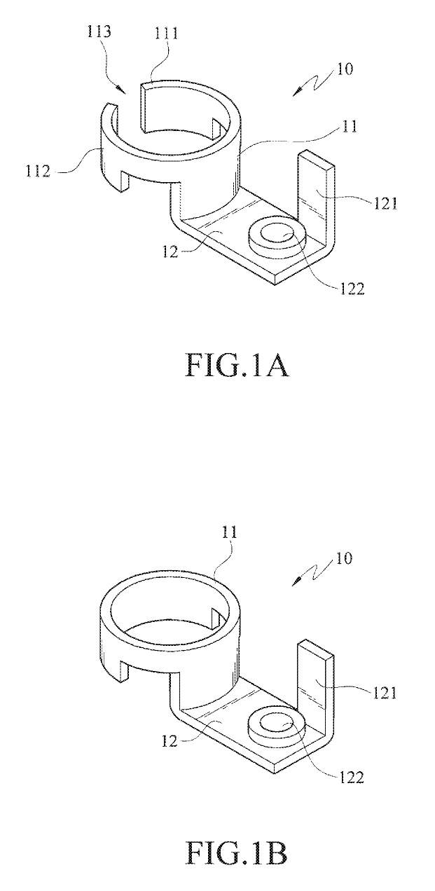

FIG. 1A is a schematic view of a conductive element according to an embodiment of the present invention, and FIG. 1B is a schematic view of an external appearance of a conductive element according to another embodiment of the present invention.

Referring to FIG. 1A, a conductive element 10 according to the present invention is made of a metal material, and comprises a sleeve portion 11 and a conductive portion 12. The sleeve portion 11 is in an annular shape surrounded by a first clamping arm 111 and a second clamping arm 112. The first clamping arm 111 and the second clamping arm 112 respectively extend from two opposite sides of the conductive portion 12 to form an opened ring-shaped configuration. A gap 113 (as shown in FIG. 1A) exists between ends of the first clamping arm 111 and the second clamping arm 112. The gap 113 as shown in the drawing provides a space for the elastic deformation of the first clamping arm 111 and the second clamping arm 112, such that the first clamping arm 111 and the second clamping arm 112 are enabled to realize an inward pressing motion or an outward restoring motion, but the present invention is not limited here. Alternatively, the sleeve portion 11 may be an enclosed ring-shaped configuration (as shown in FIG. 1B), which merely enables the discharge lamp tube go through the sleeve portion 11 of the conductive element 10.

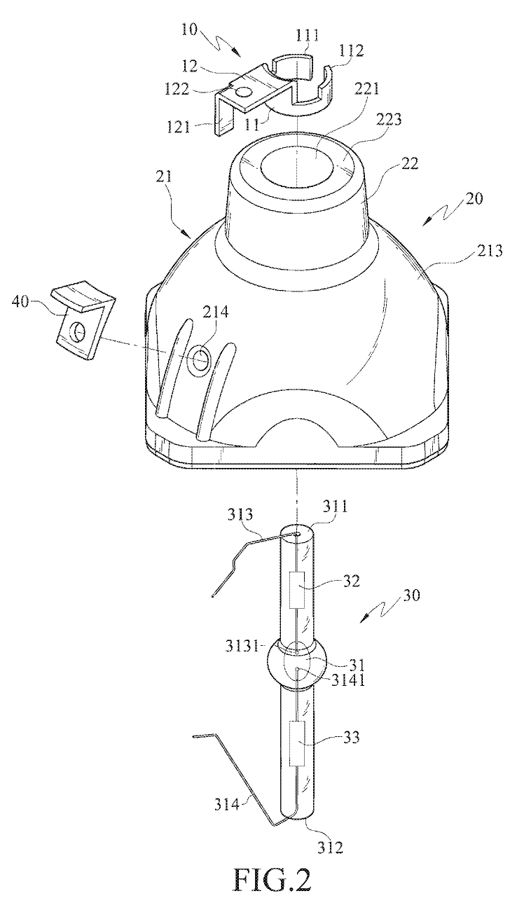

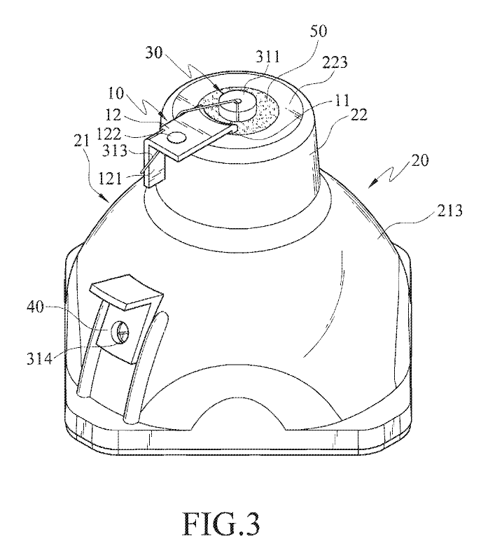

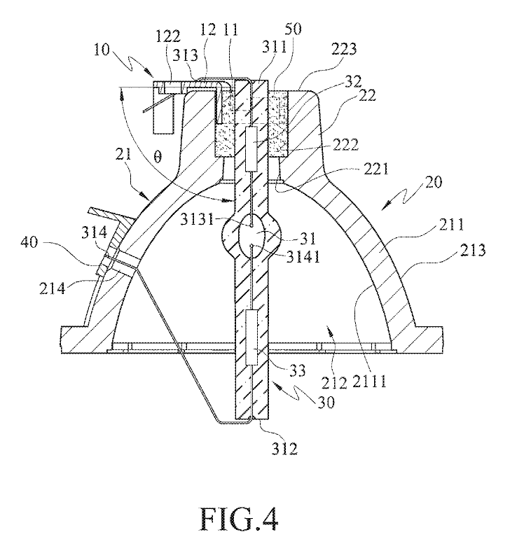

FIG. 2 is a schematic view of a lamp according to an embodiment of the present invention. FIG. 3 is a schematic view of the lamp according to an embodiment of the present invention. FIG. 4 is a schematic cross-sectional view of the lamp according to an embodiment of the present invention.

In the lamp according to the present invention, a conductive element 10 is installed on a lamp reflector 20, and the lamp reflector 20 at least comprises a main body 21 and a neck portion 22 disposed on one side of the main body 21. The main body 21 is surrounded by a surrounding wall 211. A reflecting surface 2111 on an inner wall of the surrounding wall 211 forms a reflecting chamber 212 within the surrounding wall 211. The neck portion 22 is connected to a central position of the surrounding wall 211 of the main body 21, and an opening 221 and a receiving chamber 222 are disposed in the neck portion 22.

The opening 221 communicates with the receiving chamber 222. The opening 221 through from the reflecting surface 2111 of the surrounding wall 211 to an interior of the neck portion 22 to communicate with the reflecting chamber 212. The receiving chamber 222 goes through the end wall surface 223 of the neck portion 22 to the interior of the neck portion 22, such that a size of the receiving chamber 222 is larger than that of the opening 221. The receiving chamber 222 is provided for assembling the sleeve portion 11 of the conductive element 10. The design of the receiving chamber 222 is an exemplary embodiment of the structure of the neck portion 22, and the present invention is not limited to the receiving chamber 222. Alternatively, the neck portion 22 may only have the opening 221 going therethrough, such that the sleeve portion 11 of the conductive element 10 is directly assembled in the opening 221.

In addition, the main body 21 further comprises a hole 214. The hole 214 goes through the reflecting surface 2111 of the surrounding wall 211 to an outer wall surface 213 of the surrounding wall 211. An electrical connecting piece 40 is disposed on the main body 21 at a position corresponding to the hole 214.

The lamp further comprises a discharge lamp tube 30. A discharge space 31 is formed in the middle of the discharge lamp tube 30, and at least one rare gas, a halide, and a metal are filled in the discharge space 31. A first end 311 and a second end 312 are respectively disposed at two opposite sides of the discharge lamp tube 30. The first end 311 has a first wire 313, and the second end 312 has a second wire 314. The two wires 313 and 314 are electrically connected to a first metal foil 32 and a second metal foil 33 respectively. The metal foils 32 and 33 may be, but not limited to, made of molybdenum (Mo). The two metal foils 32 and 33 are sealed within the discharge lamp tube 30, and one end of the metal foil 32 and one end of the metal foil 33 are connected to a tip 3131 of a first electrode and a tip 3141 of a second electrode. The tips 3131 and 3141 of the two electrodes are located in the discharge space 31, and the tips 3131 and 3141 of the two electrodes are separated from each other and are in a state corresponding to each other (as shown in FIG. 4). When the two wires 313 and 314 generate a high voltage difference there-between, the tips 3131 and 3141 of the two electrodes in the discharge space 31 generate an electric arc through the two metal foils 32 and 33, and the electrons in the electric arc bombard the atoms volatilized to a gas state in the discharge space 31, such that light are emitted in the discharge space 31. The discharge lamp tube 30 belongs to the prior art, so it is not described in detail here.

When the lamp according to the present invention is assembled, the first end 311 of the discharge lamp tube 30 goes through the opening 221 of the neck portion 22, and the sleeve portion 11 of the conductive element 10 is installed in the receiving chamber 222 of the neck portion 22, such that the sleeve portion 11 is sleeved on the discharge lamp tube 30. The first clamping arm 111 and the second clamping arm 112 clamp the first end 311 of the discharge lamp tube 30. In this manner, the discharge lamp tube 30 is stably clamped and positioned by the conductive element 10, and the conductive element 10 forms an included angle θ with the discharge lamp tube 30 (as shown in FIG. 4, the included angle θ is 90 degrees, but the present invention is not limited here).

A cement 50 is filled in the receiving chamber 222, and covers the sleeve portion 11 of the conductive element 10, such that the conductive element 10 and the discharge lamp tube 30 do not easily shake within the lamp reflector 20.

The first wire 313 of the first end 311 goes through out of the cement 50, and is electrically connected to the conductive portion 12 of the conductive element 10, and the second wire 314 through the hole 214 and is electrically connected to the electrical connecting piece 40. In addition, the conductive portion 12 further comprises a support plate 121 and at least one locking hole 122. The support plate 121 is bent from one side edge of the conductive portion 12, and the first wire 313 is soldered on the support plate 121. However, the structural design of the support plate 121 is only an exemplary embodiment, and the present invention is not limited here. Alternatively, the first wire 313 may be directly soldered on the conductive portion 12 for realizing an electrical connection. In addition, the locking hole 122 of the conductive portion 12 is provided for a locking element (not shown) to pass through, and the locking element is used to lock a wire (for example, a wire of a projection device) in the locking hole 122 of the conductive portion 12.

The conductive element and the lamp using the conductive element according to the present invention have the following effects. After being sleeved on the discharge lamp tube, the sleeve portion of the conductive element is assembled in the neck portion of the lamp reflector, such that the conductive portion of the conductive element forms an included angle with the discharge lamp tube. In this manner, a length achieved after the discharge lamp tube and the lamp reflector are assembled together is shortened, such that the lamp is not limited by a total length, and can be assembled to an electronic product with a small space (for example, a projection device).

What is claimed is:

1. A conductive element, applicable to a lamp having a discharge lamp tube, the conductive element comprising:
a sleeve portion; and
a conductive portion, extending from the sleeve portion, and forming an included angle with the discharge lamp tube.

2. The conductive element according to claim 1, wherein the conductive portion further comprises a locking hole.

3. The conductive element according to claim 1, wherein the sleeve portion is an enclosed ring-shaped body.

4. The conductive element according to claim 1, wherein the sleeve portion is an opened ring-shaped body.

5. The conductive element according to claim 1, wherein the included angle between the conductive portion and the discharge lamp tube is 90 degrees.

6. A lamp, comprising:
a lamp reflector, having a main body and a neck portion connected to each other, wherein the main body has a reflecting chamber therein, and the neck portion has an opening through the neck portion and communicating with the reflecting chamber;
a conductive element, having a sleeve portion and a conductive portion, wherein the sleeve portion is installed in the opening, and the conductive portion extends from the sleeve portion; and
a discharge lamp tube, disposed within the reflecting chamber, and having a first end and a second end, wherein the first end goes through the opening and the sleeve portion, such that the discharge lamp tube forms an included angle with the conductive portion, and the first end has a first wire electrically connected to the conductive portion.

7. The lamp according to claim 6, wherein the main body of the lamp reflector further comprises a via hole and an electrical connecting piece, and the electrical connecting piece is disposed on the main body at a position corresponding to the via hole; and the discharge lamp tube further comprises a second wire, and the second wire is disposed on the second end of the discharge lamp tube, through the via hole, and is electrically connected to the electrical connecting piece.

8. The lamp according to claim 6, wherein the neck portion of the lamp reflector further comprises a receiving chamber, disposed within the neck portion and communicating with the opening.

9. The lamp according to claim 6, wherein the conductive portion further comprises a locking hole.

10. The lamp according to claim 6, wherein the sleeve portion is an enclosed ring-shaped body.

11. The lamp according to claim 6, wherein the sleeve portion is an opened ring-shaped body.

12. The lamp according to claim 6, wherein the included angle between the conductive portion and the discharge lamp tube is 90 degrees.

13. The lamp according to claim 6, further comprising a cement, filled in the opening and covering the sleeve portion.
